(19) United States
(12) Patent Application Publication
(10) Pub. No.: US 2016/0077398 A1
(43) Pub. Date: Mar. 17, 2016

(54) METAL-BASED PLUGS FOR ELECTROCHROMIC DEVICES

(71) Applicant: Gentex Corporation, Zeeland, MI (US)

(72) Inventors: Kevin L. ASH, ZEELAND, MI (US); Kristopher R. GREEN, ZEELAND, MI (US); Michael T. STEPHENSON, ZEELAND, MI (US)

(21) Appl. No.: 14/834,849

(22) Filed: Aug. 25, 2015

Related U.S. Application Data
(60) Provisional application No. 62/050,349, filed on Sep. 15, 2014.

(51) Int. Cl. G02F 1/161

(52) U.S. Cl. CPC G02F 1/161

(57) ABSTRACT

An electrochromic device includes a first substrate having an electrically conductive material associated therewith, a second substrate having an electrically conductive material associated therewith, a chamber positioned in a center of the electrochromic device, an electrochromic medium contained within the chamber, at least one fill port extending between at least one of the first substrate and the second substrate and the chamber, at least one plug associated with the at least one fill port, and a metal sealing member disposed on a surface of the at least one of the first substrate and the second substrate. The metal sealing member configured to hermetically seal the at least one fill port.

### CROSS-REFERENCE TO RELATED APPLICATIONS

This application claims the benefit of U.S. Provisional Patent Application No. 62/050,349, filed on Sep. 15, 2014, the entire disclosure of which is hereby incorporated by reference for all purposes in its entirety as if fully set forth herein.

### FIELD

The present technology relates generally to the field of electrochromic devices and apparatuses incorporating these devices. More particularly, the technology relates to metal plugs associated with a fill port of an electrochromic device.

### SUMMARY

In one embodiment, an electrochromic device includes a first substrate having an electrically conductive material associated therewith, a second substrate having an electrically conductive material associated therewith, a chamber positioned in a center of the electrochromic device, an electrochromic medium contained within the chamber, at least one fill port extending between at least one of the first substrate and the second substrate and the chamber, at least one plug associated with the at least one fill port, and a metal sealing member disposed on a surface of the at least one of the first substrate and the second substrate. The metal sealing member configured to hermetically seal the at least one fill port.

In another embodiment, an electrochromic aircraft transparency includes a first substrate having an electrically conductive material associated therewith, a second substrate having an electrically conductive material associated therewith, a chamber positioned in a center of the electrochromic device, an electrochromic medium contained within the chamber, at least one fill port extending between at least one of the first substrate and the second substrate and the chamber, at least one plug associated with the at least one fill port, and a metal sealing member disposed on a surface of the at least one of the first substrate and the second substrate. The metal sealing member configured to hermetically seal the at least one fill port.

Additional features, advantages, and embodiments of the technology may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure will become more fully understood from the following detailed description, taken in conjunction with the accompanying figures, in which:

FIG. 1 is a cross-sectional schematic representation of an electrochromic device showing, among other things, a metal-based plug associated with a fill port of a substrate, according to one embodiment.

FIG. 2 is a cross-sectional schematic representation of an electrochromic device showing, among other things, a metal-based plug associated with multiple fill ports and multiple plugs in various locations on the device, according to various embodiments.

FIG. 3 is a cross-sectional schematic representation of an electrochromic device showing, among other things, a metal-based plug associated with a fill port in the sealing member of a device, according to various embodiments.

FIG. 4 is a photo of a metal-based plug sealing a fill port of an electrochromic device, according to various embodiments.

FIG. 5 is a photo of a standard glass slipcover adhered in place with epoxy exhibiting “glow” as hereinafter described.

FIG. 6 is a close-up photo of the standard glass slipcover adhered in place with epoxy exhibiting “glow” as hereinafter described.

FIG. 7 is a close-up photo of the same window as in FIG. 6, except the standard glass slipcover (which was adhered in place with epoxy) has been removed and replaced with a metal-base plug (NJ-215 from Nano Joint Company, Chiba, Japan).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

Electrochromic devices can be used in a wide variety of applications wherein the transmitted or reflected light/heat can be modulated. Such devices include mirrors; aircraft transparencies; windows for the exterior of a building, home or vehicle; skylights for buildings including tubular light filters; windows in office or room partitions; and light filters for photographic devices and light sensors. Where the electrochromic devices are filled with a solution, the devices include a “fill port” where fluids (i.e. solutions) are introduced to the device. After filling, the fill port is then closed, i.e. plugged, to prevent or minimize gases, such as air, or other materials from entering the device and also to prevent the fluid from exiting the device.

Typically, a curable resin is introduced to the fill port after filling of the device, the curable resin then being cured to form a primary plug that effects closure of the fill port. In some instances a backup resin is then used as a secondary plug providing protection to the primary plug and additional benefits to the device. For example, the resin used to form the primary plug is typically immiscible, or at least substantially immiscible, with the solution or fluid such that it does not mix or dissolve in the fluid upon filling. The primary plug affects a first closure of the device. However, the primary plug may, in some instances, be permeable to gases or liquids, or the primary plug may not provide an optical barrier thereby allowing for light penetration or transparency. A secondary plug then provides a gas or water barrier to prevent or minimize incursion of gas or water into the device, there minimizing or preventing deleterious effects on the fluid inside the electrochromic device. The secondary plug is typically formed from a curable resin as well. However, provided herein is a metal-based plug that provides a barrier to not only gases and liquids, but is also an optical barrier covering “glow” associated with the primary plug. The metal-based plug may be employed as a secondary plug, or even a tertiary plug, associated with the fill port of an electrochromic device.

As used herein, “glow” refers to the undesirable transmission or diffraction of light through primary plug material, producing a region of brightness adjacent to the fill port when compared to the rest of the device when in a darkened, or low transmission state. The metal-based plugs minimize or eliminate the glow due to the ability of the metal to act as a light, or optical, barrier.

The metal-based plug is provided as a secondary or tertiary plug, covering the primary or secondary plugs, respectively. The metal-based plugs include flowable metals that when contacted with a glass substrate used in the construction of the electrochromic device seal to the device. For example, and without limitation, the metal-based plugs may be formed from metal ingots or solders that are meltable and flowable at various temperatures on the electrochromic device substrates. The metals for the metal-based plugs may include metals and/or their alloys and/or mixtures drawn from: tin, tin alloys, tin solders, silver, silver alloys, silver solders, zinc, zinc alloys, zinc solders, antimony, antimony alloys, antimony solders, silver, silver alloys, silver solders, aluminum, aluminum alloys, aluminum solders, germanium, germanium alloys, germanium solders, titanium, titanium alloys, titanium solders, gold, gold alloys, gold solders, platinum, platinum alloys, platinum solders, copper, copper alloys, copper solders, palladium, palladium alloys and palladium solders. Such materials may readily bind to glass or plastic substrates of the electrochromic device providing an impervious seal over a fill port associated with the device.

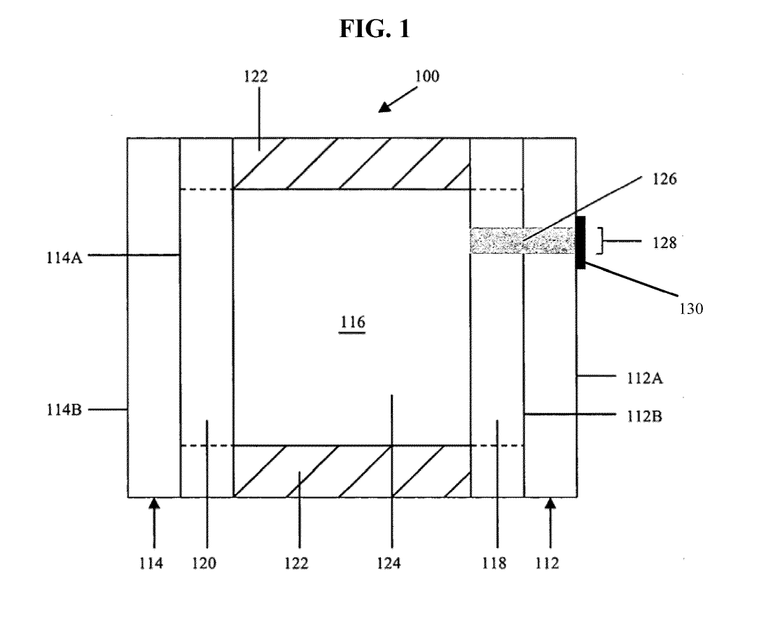

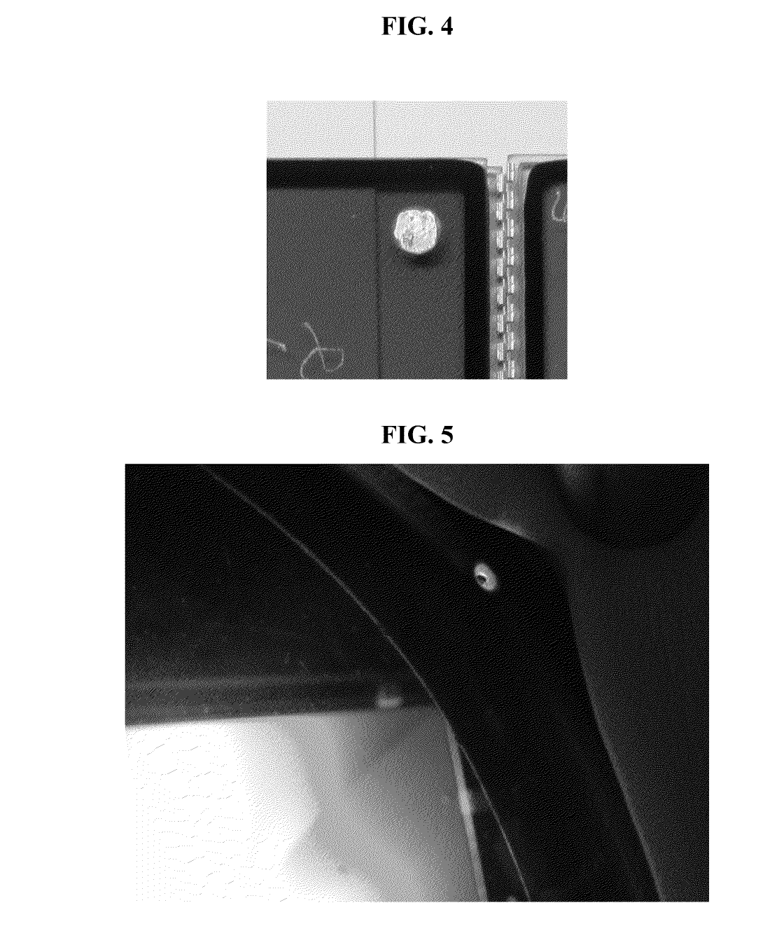

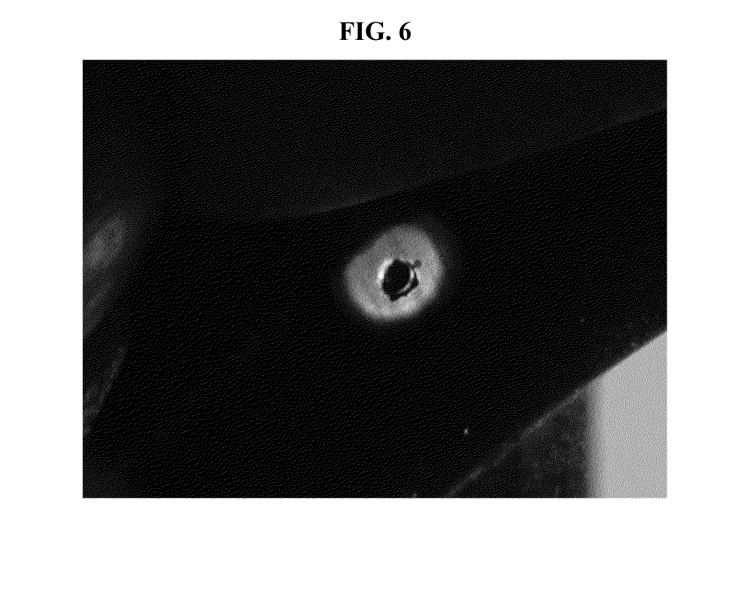

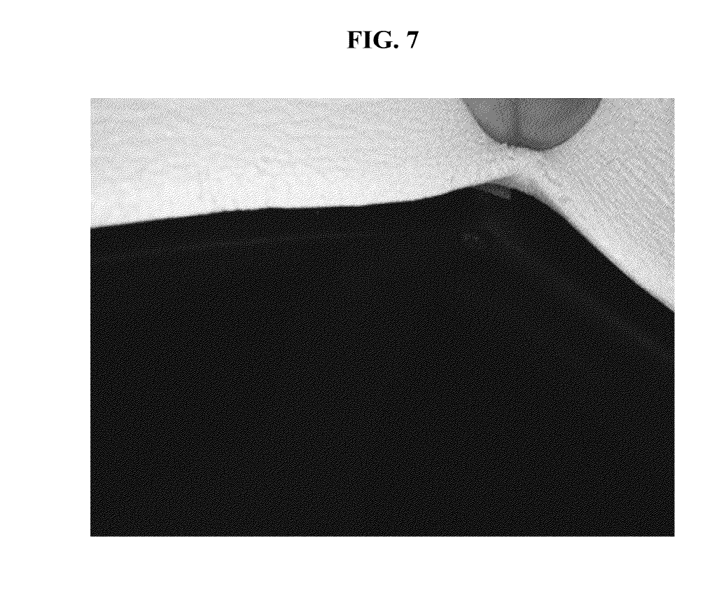

Referring now to the drawings, and to FIGS. 1-3 in particular, cross-sectional schematic representations of electrochromic devices 100 are shown, which generally include a first substrate 112 having a front surface 112A and a rear surface 112B, and a second substrate 114 having a front surface 114A and a rear surface 114B. The front surface 112A and the front surface 114A have associated therewith conductive surfaces 118 and 120, respectively. The first substrate 112 and the second substrate 114, along with a sealing member 122 define a chamber 116 for containing an electrochromic medium 124. The device also includes one or more plugs 126 associated with one or more fill ports 128. The one or more fill ports 128 may be disposed within the first substrate 112, the second substrate 114, and/or the sealing member 122. Over-covering the one or more plugs 126 is a metal-based plug 130 hermetically sealing the one or more plugs 126 and the one or more fill ports 128. In some embodiments, the metal-based plug 130 may have a thickness of 0.05 mm to 2.0 mm. In order to eliminate the “glow,” the metal-based plug 130 must be large enough to cover the inner plug (e.g., one or more plugs 126, if one is used) and the one or more fill ports 128. Upon mounting as a mirror, window, or other device, the electrochromic device 100 may optionally include a bezel that extends around a periphery of at least one of the first substrate 112 and the second substrate 114 to conceal and/or protect a bus connector (if present), the sealing member 122, one or more plugs 126, the one or more fill ports 128, and the metal-based plug 130. FIG. 4 is a photograph of a metal-based plug sealing a fill port and overcovering a primary plug.

In one aspect, a primary plug is associated with fill port 128, which preferably includes an epoxy resin or mixture of resins and which is at least partially cured. The primary plug makes up at least one of the one or more plugs 126. Where there are at least two plugs 126, the primary plug is composed of the first plug material to be placed in the fill port 128 and abuts the electrochromic medium 124. As noted, the primary plug may be compatible with an electrochromic medium 124 that is introduced to the chamber 116. As introduced above, during normal fabrication of an electrochromic device 100, the fill port 128 is utilized to introduce the electrochromic medium 124 into the chamber 116 of electrochromic device 100. However, there are multiple ways in which the electrochromic medium may be introduced to the chamber.

For example, in certain embodiments, a partially fabricated electrochromic device 100 is placed with fill port 128 downward in an empty container or trough in a vacuum vessel, where the device is evacuated. The electrochromic medium 124 is introduced to the trough or container in a manner such that fill port 128 is submerged with sufficient fluid such that upon filling the chamber will fill with the medium and not cause gas to enter the device. The vacuum is then released, typically under force of an inert gas, which causes the electrochromic medium 124 to enter the device through fill port 128 and into the chamber 116. In certain other embodiments, a partially fabricated electrochromic device 100 having a single fill port 128 in one of the substrates of the device is placed in a vacuum vessel with the fill port in an upward direction, and the device is then evacuated. The electrochromic medium 124 is then introduced into the container via a conduit to the fill port 128. In yet another embodiment (not shown), the electrochromic device may have at least two fill ports, whereby under an inert atmosphere the electrochromic medium is introduced to the chamber under pressure at a first fill port. As the medium enters the chamber it spreads out to fill the chamber with gas within the chamber exiting from at least a second fill port. The above illustrative filling methods are not exclusive.

Upon filling by any of the above processes, the fill port(s) 128 is plugged with a curable resin, followed by at least partial curing of the curable resin to form the primary plug. In some embodiments, the curable resin is a photocurable resin. After the primary plug is at least partially cured, a secondary plug may be used to back up or overcoat the primary plug. The secondary plug may be a resin-based plug or a metal-based plug. If the secondary plug is a resin-based plug, then a metal-based tertiary plug may be used to cover over both the primary and secondary plugs.

The metal-based plugs hermetically seal over the primary plug and any optional secondary, resin-based plugs. In one embodiment, the metal-based plug 130 is a metal, metal alloy, or metal solder. The metals for the metal-based plugs 130 may include metals and/or their alloys and/or mixtures drawn from: tin, tin alloys, tin solders, silver, silver alloys, silver solders, zinc, zinc alloys, zinc solders, antimony, antimony alloys, antimony solders, silver, silver alloys, silver solders, aluminum, aluminum alloys, aluminum solders, germanium, germanium alloys, germanium solders, titanium, titanium alloys, titanium solders, gold, gold alloys, gold solders, platinum, platinum alloys, platinum solders, copper, copper alloys, copper solders, palladium, palladium alloys and palladium solders. The following are examples of metal compositions that may be used for the metal-based plugs 130.

### EXAMPLE 1

### Composition of NJ-215 from Nano Joint Company (Chiba, Japan)

| Product Name | Chemical name | Chemical formula | Content (wt %) |
|---|---|---|---|
| NJ-216 For | \textcircled{1} Tin | Sn | 94.5 ± 1.0 |
| Glass Solder | \textcircled{2} Zinc | Zn | 4.0 ± 1.0 |
| | \textcircled{3} Antimony | Sb | 1.0 ± 0.3 |
| | \textcircled{4} Silver | Ag | 0.1 ± 0.2 |
| | \textcircled{5} Aluminum | Al | 0.01 ± 0.003 |
| | \textcircled{6} Germanium | Ge | 0.01 ± 0.003 |
| | \textcircled{7} Silicon | Si | 0.005 ± 0.002 |
| | \textcircled{8} Titanium | Ti | 0.005 ± 0.002 |
| | \textcircled{9} Others | | 0.01 [symbol] |

### EXAMPLE 2

### Composition of “GLS” from Senju Metal Industry Company (Tokyo, Japan)

Concentration or concentration range:

| | | | Official gazette control No. | | |
|---|---|---|---|---|---|
| | | | Law Concern- | | |
| | | | ing the Exam- | | |
| | | | ination and | | |
| | | | Regulation of | Industial | |
| Chemical | | | Manufacture, | Safety | |
| name or | | | etc. of | and | |
| common | Abbre- | Content | Chemical | Hygiene | |
| name | viation | (wt %) | Substances | Law | CAS No. |
| Tin | — | 90~ | Not | Not | 7440-31-5 |
| | | 100% | applicable | applicable | |
| Antinony | — | 5% | Not | Not | 7440-36-0 |
| | | | applicable | applicable | |
| Zinc | — | 1~5% | Not | Not | 7440-66-6 |
| | | | applicable | applicable | |

### EXAMPLE 3

### Composition of “Cerasolzer ECO 217” from Senju Metal Industry Company (Tokyo, Japan)

| Hazardous | | | | |
|---|---|---|---|---|
| Components | CAS No. | OSHA PEL | ACGIH TLV | % |
| Tin | 7440-31-5 | 2 mg/m³ (8 Hr- | 2 mg/m³ (8 Hr- | 94~96 |
| | | TWA) | TWA) | |

*Current OSHA standard, and ACGIH (1980) Intended changes
List for tin, tin oxide, and inorganic compounds (except SnH4), as Sn.
STEL is for 4 mg/m³

| | | | | |
|---|---|---|---|---|
| Antimony | 7440-36-0 | 0.5 mg/m³ (8 Hr- | 0.5 mg/m³ (8 Hr- | 3~5 |
| | | TWA) | TWA) | |
| Zinc | 7440-66-6 | | | 1~3 |

### EXAMPLE 4

### Composition of “INDALLOY Containing Indium with Tin, Lead, or Silver” from Indium Corporation of America (Utica. N.Y.)

ALLOY TABLE

| INDALLOY | % | % | % | % | | | |
|---|---|---|---|---|---|---|---|
| METAL | INDIUM | TIN | LEAD | SILVER | RoHS*** | LIQUIDUS | DENSITY |
| MIX | (In) | (Sn) | (Pb) | (Ag) | Compliance | ° C./° F. | (gm/cm³) |
| 1 | 50 | 50 | — | — | Y | 125 C./257 F. | 7.30 |
| 1E | 52 | 48 | — | — | Y | 118 C./244 F. | 7.30 |
| 2 | 80 | — | 15 | 5 | N | 154 C./309 F. | 7.85 |
| 3 | 90 | — | — | 10 | Y | 237 C./459 F. | 7.54 |
| 5 | 25 | 37.5 | 3.75 | — | N | 181 C./358 F. | 8.42 |
| 6 | 4.76 | — | 92.86* | 2.38 | Y | 300 C./572 F. | 11.03 |
| 7 | 50 | — | 50 | — | N | 210 C./410 F. | 8.86 |
| 9 | 12 | 70 | 18 | — | N | 167 C./333 F. | 7.79 |
| 10 | 25 | — | 75 | — | N | 260 C./500 F. | 9.97 |
| 11 | 5 | — | 95* | — | Y | 313 C./595 F. | 11.06 |
| 12 | 5 | — | 90* | 5 | Y | 310 C./590 F. | 11.00 |
| 70 | 40 | 40 | 20 | — | N | 130 C./266 F. | 7.86 |
| 71 | 48 | 52 | — | — | Y | 131 C./268 F. | 7.30 |
| 87 | 42 | 58 | — | — | Y | 145 C./293 F. | 7.30 |
| 150 | 19 | — | 81 | — | Y | 275 C./527 F. | 10.27 |
| 164 | 5 | — | 92.5* | 2.5 | Y | 310 C./590 F. | 11.02 |
| 204 | 70 | — | 30 | — | N | 175 C./347 F. | 8.19 |
| 205 | 80 | — | 40 | — | N | 181 C./358 F. | 8.52 |
| 206 | 40 | — | 60 | — | N | 231 C./448 F. | 9.30 |
| 225 | 90 | 10 | — | — | Y | 151 C./304 F. | 7.31 |
| 227 | 20 | 77.2 | — | 2.8 | Y | 187 C./369 F. | 7.25 |
| 230* | 20 | 54 | 28 | — | N | 152 C./306 F. | 8.08 |
| 235 | 58 | — | 39 | 3 | N | 195 C./383 F. | 8.59 |
| 237 | 2 | 3 | 93* | 2 | Y | 304 C./579 F. | 11.07 |
| 239 | 1 | 4 | 91* | 4 | Y | 313 C./595 F. | 11.05 |
| 254 | 10 | 86.9 | — | 3.1 | Y | 205 C./401 F. | 7.37 |
| 290 | 97 | — | — | 3 | Y | 143.3 C./290 F. | 7.38 |
| 532* | 20 | 54 | 26 | — | N | 152 C./306 F. | 8.06 |

NON-STANDARD MIXTURES

| | | | | | | | |
|---|---|---|---|---|---|---|---|
| NS | 0.75 | — | 96.75*- | 2.5 | Y | — | 11.28 |
| NS | 2 | 98 | — | — | Y | — | 7.28 |
| NS | 10 | — | 90* | — | Y | — | 10.79 |
| NS | 30 | 70 | — | — | Y | — | 7.29 |
| NS | 35 | 65 | — | — | Y | — | 7.29 |
| NS | 37 | — | 62.8 | 0.4 | N | — | 9.41 |
| NS | 38 | 62 | — | — | Y | — | 7.29 |
| NS | 20 | 40 | 40 | — | N | — | 8.50 |
| NS | 50 | 48 | — | 2 | Y | — | 7.34 |
| NS | 62.8 | — | 43.9 | 3.3 | N | — | 8.76 |
| NS | 65 | 35 | — | — | Y | — | 7.29 |
| NS | 75 | — | 25 | — | N | — | 8.01 |
| NS | 75 | 25 | | | Y | — | 7.29 |
| NS | 95 | 5 | — | — | Y | — | 7.30 |
| NS | 97 | — | — | 3 | Y | — | 7.37 |
| NS | 98 | — | — | 2 | Y | — | 7.34 |

| | |
|---|---|
| NS GENERAL | Non-standard ranges for Indium (80-99%) with silver (1-20%) containing other than |
| | those specifically listed above. All of these comply with RoHS. |

*doped with 0.12%-0.16% copper
NS = Non Standard Alloy Mixture

### EXAMPLE 5

### Composition of Indium/Tin from Antaya Technologies Corporation (Cranston, R.I.)

Antaya Technologies Corporation utilizes a number of indium and tin alloy solder compositions for use in conjunction with glass or electronic devices. For example, in U.S. Pat. No. 8,771,592, the entire contents of which is hereby incorporated by reference, Antaya Technologies Corporation discloses a lead-free solder composition including about 4% to about 25% by weight tin, about 0.1% to about 8% by weight antimony, about 0.03% to about 4% by weight copper, about 0.03% to about 4% by weight nickel, about 66% to about 90% by weight indium, and about 0.5% to about 9% by weight silver. The composition can further include about 0.2% to about 6% by weight zinc, and, independently, about 0.01% to about 0.3% by weight germanium.

As another example, in U.S. Pat. No. 6,253,988, the entire contents of which is hereby incorporated by reference, Antaya Technologies Corporation discloses a solder composition with a weight percentage of 64.35%-65.65% indium, 29.7%-30.3% tin, 4.05%-4.95% silver, 0.25%-0.75% copper. The solder composition preferably contains no more than about 0.75% antimony, about 0.08% gold, about 0.2% lead, about 0.08% aluminum, about 0.03% arsenic, about 0.005% cadmium, about 0.005% zinc, about 0.25% bismuth, about 0.02% iron and about 0.005% nickel.

In practice, a metal-based plug material is melted and applied to overcover the one or more plugs 126, and one or more fill ports 128. Where the fill port and primary plug material are located on an edge of the electrochromic device, i.e. where the fill port is a void in the seal member 130, the metal-based plug material may be melted and applied to the edge of the electrochromic device at the fill port. In other instances, the fill port may consist of a hole or holes drilled through substrate 112 or 114. After application, the metal-based plug material is allowed to cool thereby forming the metal-based plug. The metal-based plug material is configured to have a lower melting point than the substrate to which it applied. The metal-based plug material may be a solder composition.

The metal-based plugs provide several advantages. For example, use of the metal-based plugs eliminates the use of the epoxy adhesive as a second seal which can impart glow to a device. The metal-based plugs also provide an improved hermetic seal when compared to epoxy plugs. In particular, the metal composition exhibits superior adhesion to the substrates to which it is applied when compared to the epoxy adhesive, as demonstrated by steam testing and oxygen autoclave testing. For example, using the standard approach of sealing devices by adhering a glass slipcover or glass plate over the fill hole with epoxy yields an assembly that typically delaminates under steam autoclave testing within a period of a few days. In comparison, however, metal-sealed parts in steam autoclave testing have lasted well over 30 days.

In oxygen autoclaves, in which sealed test parts are subjected to a 400 psi environment of pure oxygen, metal-sealed parts exhibit a pronounced resistance to color degradation, which is the typical issue experienced when oxygen enters through a seal and reacts with electrochromic compounds, causing undesirable color changes in electrochromic devices when viewed in the clear (unpowered) state.

Moreover, the metal-based plugs are impervious to light, which eliminates, or at least minimizes the light diffraction transferred through the plug area. Since parts of the plug system rely on a curable inner, immiscible plug, there is a small region inside of the electrochromic device (under the slipcover) that does not contain electrochromic media. As a result, when the electrochromic device is in the darkened state, this area occludes light only as well as the glass slipcover and adhering epoxy. When the electrochromic device is in low transmissivity states, light can bleed through the glass slipcover/epoxy producing an undesirable “glow” or region that transmits more light than the electrochromic media. This “glow” or “spot” is undesirable.

Additionally, efforts to decrease the “glow” by incorporating increasing levels of black pigment into the epoxy have not eliminated the issue, and can result in reduced adhesion of the glass slipcover to the glass substrate 112 or 114 (first surface) of the electrochromic device. The metal-based slipcover is completely impervious to light transmission and eliminates the “glow” issue. In addition, because the metal-based plugs are impervious to gas, the metal-based plugs prevent, or at least minimize oxygen, moisture and other contaminants from entering the electrochromic device 100.

With respect to the primary plug materials, the formulation of plug 126 includes an epoxy resin or mixture of resins (e.g. cycloaliphatic epoxy resins including, for example, Omnilane OC1005, which is available from IGM Resins Inc., Bartlett, Ill., aromatic epoxy resins including, for example, Bis-F, Bis-A, and/or epoxy novolac resins including, for example, DER 354, DER 332, and DEN 431, which are all available from the Dow Chemical Company—all of which may be optionally filled with fumed silica or other fillers such as glass beads, calcium carbonate, aluminum oxide, calcium fluoride, or other fillers as desired) which may be at least partially cured using one or more photoinitiators, as are known in the art. In some embodiments, the formulation of plug 126 includes a resin or mixture of resins (e.g. epoxy resins, such as epoxidized polybutadienes, epoxidized castor oil, epoxidized cashew nut oil, acrylated butadiene resins, among other provided herein) that are substantially insoluble and/or substantially immiscible with an associated electrochromic medium (i.e. 124) while in the uncured state. By way of supporting examples, the resin or mixture of resins may include Sartomer CN-301, Sartomer CN-304, Rhan BR-643.

It will be understood that resins other than acrylated (Sartomer CN-301), methacrylated (Sartomer CN-304) or epoxidized polybutadiene may be used in a plug formulation, and that the resins are at least substantially insoluble and/or at least substantially immiscible in the EC media. Insoluble monomers or oligomers that may be used in the primary plug resin materials include, but are not limited to, those available from Sartomer such as CN-986 aliphatic urethane acrylate), CN-2252 (polyester acrylate), CN-934 (aliphatic urethane acrylate), CN-975 (hexafunctional urethane acrylate), CN-965 (aliphatic urethane acrylate), CN-981 (aliphatic urethane acrylate) CN-973 (aromatic urethane acrylate), SR-489 (tridecyl acrylate) and SR-335 (lauryl acrylate).

In yet another embodiment the formulation of plug 126 includes two-parts, namely; a first sub-component comprising a resin or mixture of resins (e.g. epoxy resins, acrylated butadiene resins, among other provided supra and infra) that are substantially insoluble and/or substantially immiscible with an associated electrochromic medium (i.e. 124) while in the uncured state, and a second-subcomponent comprising a resin or mixture of resins (e.g. epoxy resins, urethane resins, phenolic resins, acrylic resins, cured at room temperature, thermally and/or with radiation, among other provided supra and infra) that exhibit desired permeability, adhesion, and/or stability characteristics. In particular, the permeability of the second-subcomponent will preferably protect electrochromic medium 124 from air and/or moisture if the first-subcomponents exhibits permeability to air and/or moisture. Furthermore, the second-subcomponent will preferably adhere to at least the first-subcomponent toward maintaining device integrity over long periods of time—including one or more decades depending upon the application of the particular electrochromic device.

Additional non-limiting examples of resins that are suitable for use as the secondary plug resinous material include those resins that are also photolytically cured. The resins may include a photoinitiator, such as, but not limited to, aliphatic amines, cycloaliphatic amines, amidoamines, mercaptans, cycloaliphatic epoxy resins such as Omnilane OC1005, which is available from IGM Resins Inc., Bartlett, Ill., aromatic epoxy resins such as Bis-F, Bis-A, and/or epoxy novolac resins such as DER 354, DER 332, and DEN 431, which are all available from the Dow Chemical Company, as well as thermal and/or photoinitiators, and optionally filled with fumed silica or other fillers such as glass beads, calcium carbonate, aluminum oxide, etcetera, using conventional techniques.

The primary plug material may be introduced into the fill port 128 and subsequently cured. A secondary resinous plug material may then be applied directly over the fill port or the primary plug, or the surrounding area of the substrate in which the fill port is located can be cleaned, etched, or cleaned and etched if desired to enhance adhesion. When desired, etching may be accomplished by several methods including mechanical etching such as sandblasting, sandpaper, or chemical etching. An additional method of cleaning the glass surface includes plasma or ion treatment. After optionally etching, the optional secondary resinous plug material may be associated with the outer surface area the first sub-component and the surrounding area. The secondary resinous plug material is generally compatible with external atmospheric conditions/parameters.

In one embodiment, the primary or secondary resinous plug materials may include one or more cure indicators which provide optical and/or measurable indication of the degree of plug curing. Cure indicators may include pH-based cure indicators, such as phenolphthalein (0.25-0.5 parts per hundred resin “phr”) and thymolphthalein (0.25-0.5 phr), which are available from Aldrich Chemical Company, free radical/reactive cure indicators such as Crystal Violet (0.25-0.5 phr), which is available from Aldrich Chemical Company, and UV cure indicators such as Blue 55 (1-5 phr), which is available from Spectra Group Limited, Inc., Millbury, Ohio. It will be understood that the concentrations of cure indicators provided above are merely suggested and are, in no way, limiting.

Primary or secondary resinous plug materials may further include one or more additives, such as, but not limited to, tougheners (e.g. Fortegra 100 (1-5 wt %) available from The Dow Chemical Company and MX136 core-shell toughener (25 wt % in Bis-F epoxy) available from Kaneka Corporation, Pasadena, Tex.), flexibilizers/crosslinkers (e.g. H2003 dendritic polymer (1-20 wt %) or CAPA polyols (1-20 wt %) available from Perstorp Polyols, Inc, Toledo, Ohio), and/or surface active agents (e.g. UV3570 (0.5-2.5 wt %) available from BYK-Chemie, Germany). It will be understood that plug tougheners and flexibilizers/crosslinkers are functionally self-explanatory, and that surface active agents can reduce the surface tension of the plug formulation and help repel the electrochromic medium during the plugging operation and reduce intermixing.

U.S. Pat. No. 7,324,261, which is hereby incorporated herein by reference in its entirety including all references incorporated therein, discloses several embodiments of different bezels that may be used with the electrochemical devices. Additionally, the bezel may be an aircraft window bezel. Such aircraft window bezels are typically made of a flexible foam or a plastic material that provides a support for an electrochromic aircraft window and contact to a structural window associated with the hull of an aircraft body.

Illustrative electrochromic devices 100 employing a metal-based plug may include, for illustrative purposes only, a window, an aircraft transparency, a mirror, a display device, and the like. It will be understood that like or analogous elements and/or components, and/or methods referred to herein, may be identified throughout the drawings with like reference characters. It will be further understood that FIGS. 1-3 are merely schematic representations of electrochromic devices 100. As such, some of the components have been distorted from their actual scale for pictorial clarity. Indeed, numerous other electrochromic device configurations are contemplated for use, including, but not limited to, those disclosed in U.S. Pat. Nos. 5,818,625; 6,597,489; and 6,700,692, all of which are hereby incorporated herein by reference in their entirety including all references incorporated therein.

In the devices, the first substrate 112 may be fabricated from any of a number of materials that are transparent or substantially transparent in the visible region of the electromagnetic spectrum, such as, for example, borosilicate glass, soda lime glass, natural and synthetic polymeric resins, plastics, ceramics and/or composites including polyesters (e.g. PET), polyimides (PI), polycarbonates, polysulfones, polyethylene naphthalate (PEN), ethylene vinyl acetate (EVA), acrylate polymers, as well as Topas®, which is commercially available from Ticona of Summit, N.J. In some embodiments, the first substrate 112 may be fabricated from a sheet of glass having a thickness ranging from approximately 0.10 millimeters (mm) to approximately 12.7 mm. This may include where the thickness is from approximately 0.50 mm to approximately 1.50 mm, in some embodiments. This may also include where the thickness is from approximately 0.75 mm to approximately 1.00 mm, in other embodiments. Of course, the thickness of the substrate will depend largely upon the particular application of the electrochromic device. While particular substrate materials have been disclosed, for illustrative purposes only, it will be understood that numerous other substrate materials are likewise contemplated for use that exhibit appropriate physical properties, such as strength, to be able to operate effectively in conditions of intended use. Indeed, electrochromic devices may be, during normal operation, exposed to extreme temperature variation as well as substantial UV radiation, emanating primarily from the sun. It will be further understood that first substrate 112, second substrate 114, or both the first and second substrates may include a UV absorbing layer and/or contain a UV absorbing material to help protect the substrate(s) and/or the electrochromic media from UV damage.

Second substrate 114 may be fabricated from similar materials as that of first substrate 112. However, if the electrochromic device is a mirror, or the electrochromic device includes a mirrored surface, depending upon the surface that incorporates the mirror, the substrate may or may not be transparent. For example, the substrate may be transparent where the distal surface is the mirrored surface, and it may not be transparent where a proximal surface is mirrored. Accordingly, materials for use as the second substrate 114 may include polymers, metals, glass, and ceramics. Second substrate 114 is may be fabricated from a sheet of glass or plastic having a thickness ranging from approximately 0.10 mm to approximately 12.7 mm. This may include where the thickness is from approximately 0.50 mm to approximately 1.50 mm, in some embodiments. This may also include where the thickness is from approximately 0.75 mm to approximately 1.00 mm, in other embodiments. If first and second substrates 112 and 114, respectively, are fabricated from sheets of glass, then the glass can optionally be tempered, heat strengthened, chemically strengthened, and/or laminated prior to or subsequent to being coated with layers of electrically conductive material (118 and 120).

One or more layers of electrically conductive material 118 are associated with rear surface 112B of first substrate 112. These layers serve as an electrode for the electrochromic device. Electrically conductive material 118 is desirably a material that: (a) is substantially transparent in the visible region of the electromagnetic spectrum; (b) bonds reasonably well to first substrate 112; (c) maintains this bond when associated with a sealing member; (d) is generally resistant to corrosion from materials contained within the electrochromic device or the atmosphere; and (e) exhibits minimal diffuse or specular reflectance as well as sufficient electrical conductance. It is contemplated that electrically conductive material 118 may be fabricated from fluorine doped tin oxide (FTO), for example TEC glass, which is commercially available from Libbey Owens-Ford-Co., of Toledo, Ohio, indium/tin oxide (ITO), doped zinc oxide, indium zinc oxide, metal oxide/Ag/metal oxide, or other materials known to those having ordinary skill in the art.

Electrically conductive material 120 may be associated with the front surface 114A of second substrate 114, and it may be operatively bonded to an electrically conductive material 118 by edge seal 122. As can be seen in FIGS. 1-3, once bonded, edge seal 122, plug 126, and the juxtaposed portions of electrically conductive materials 118 and 120 serve to generally define an inner peripheral geometry of chamber 116. Edge sealing techniques may be utilized which are disclosed in U.S. Pat. No. 7,372,611.

Electrically conductive material 120 may vary depending upon the intended use of the electrochromic device. For example, if the electrochromic device is a mirror, then the material may include a transparent conductive coating similar to electrically conductive material 118 (in which case a reflector is associated with rear surface 114B of second substrate 114). Alternatively, electrically conductive material 120 may include a layer of reflective material as shown in U.S. Pat. No. 5,818,625. In this case, electrically conductive material 120 is associated with front surface 114A of second substrate 114. Typical coatings for this type of reflector include chromium, rhodium, ruthenium, silver, silver alloys, and combinations thereof.

In some embodiments, the cell spacing between inner surfaces of substrates 112 and 114 is from approximately 10 microns (μm) to approximately 750 μm. This includes where the cell spacing is from approximately 20 μm to approximately 600 μm. It will be understood that the thickness of the cell spacing will depend largely upon the particular application of the electrochromic device.

In one embodiment, the electrochromic device 100 has a high transmittance when unpowered, or in other words in the absence of an applied potential. Conversely, when the electrochromic device is subjected to an applied potential it may have a low transmittance. In other words, unpowered, the electrochromic device allows light to pass, while in a low transmittance state light is absorbed. The amount of light that is transmitted or absorbed is dependent upon the types of substrates used and the properties of the electrochromic medium.

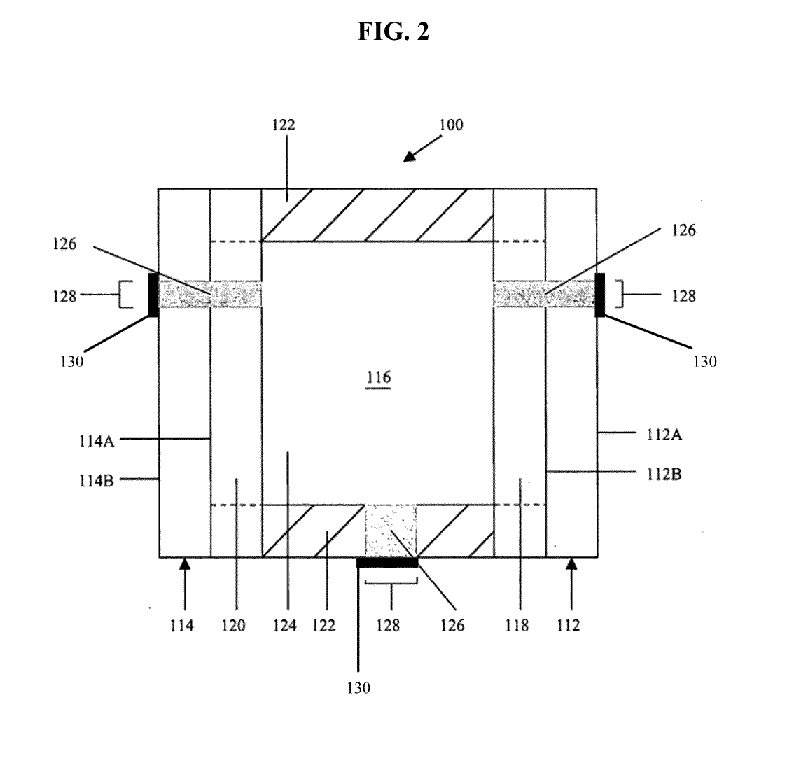

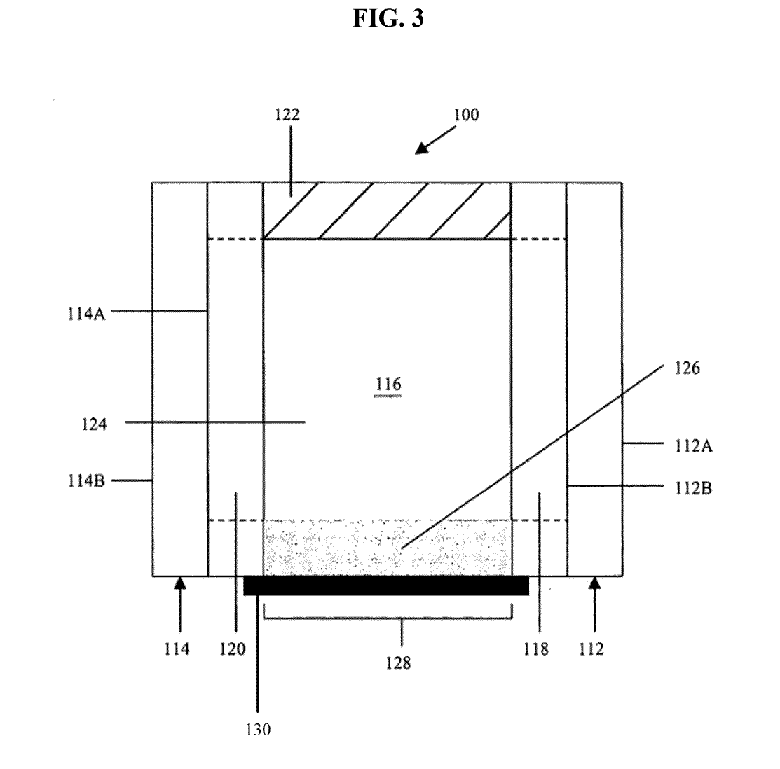

Sealing member 122 may include any material that is capable of being adhesively bonded to the electrically conductive materials 118 and 120 forming chamber 116, (in certain embodiments in cooperation with plugs 126 and fill ports 128, see FIGS. 2 and 3) so that electrochromic medium 124 does not inadvertently leak out of the chamber. As is shown in dashed lines in FIGS. 1-3, it is also contemplated that the sealing member extend all the way to rear surface 112B and front surface 114A of their respective substrates. In such an embodiment, the layers of electrically conductive material 118 and 120 may be partially removed where the sealing member 122 is positioned. If electrically conductive materials 118 and 120 are not associated with their respective substrates, then sealing member 122 preferably bonds well to substrates 112 and 114, which may be comprised of glass. It will be understood that sealing member 122 can be fabricated from any one of a number of materials including, for example, those disclosed in U.S. Pat. Nos. 4,297,401; 4,418,102; 4,695,490; 5,596,023; 5,596,024; 6,157,480; and 6,714,334.

For purposes of the present disclosure, and as will be explained in greater detail herein below, electrochromic medium 124 typically includes at least one solvent, at least one anodic material, and at least one cathodic material. Typically both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference.

The electrochromic medium may include a single-layer of material which may include small non-homogenous regions and includes solution-phase devices where a material may be contained in solution in an ionically conducting electrolyte which remains in solution in the electrolyte when electrochemically oxidized or reduced. Solution phase electroactive materials may be contained in the continuous solution-phase of a gel medium as shown in U.S. Pat. No. 5,928,572, and in International Patent Application Serial No. PCT/US98/05570, both of which are hereby incorporated herein by reference in their entirety.

More than one anodic, and/or more than one cathodic material can be combined to give a pre-selected color as described in U.S. Pat. Nos. 5,998,617; 6,020,987; 6,037,471; and 6,141,137. The anodic and cathodic materials may also be combined or linked by a bridging unit as described in U.S. Pat. No. 6,241,916 or U.S. Patent Publication No. 2002/0015214. The electrochromic materials may also include near-infrared (NIR) absorbing compounds as described in U.S. Pat. No. 6,193,912. It is also possible to link anodic materials or cathodic materials by similar methods. The anodic and cathodic electrochromic materials can also include coupled materials as described in U.S. Pat. No. 6,249,369. The concentration of the electrochromic materials can be selected as taught in U.S. Pat. No. 6,137,620. Additionally, a single-layer, single-phase medium may include a medium where the anodic and cathodic materials are incorporated into a polymer matrix as is described in International Patent Application Serial Nos. PCT/EP98/03862 and PCT/US98/05570.

The electrochromic medium may have a layered structure including a material attached directly to an electrically conducting electrode or confined in close proximity thereto which remains attached or confined when electrochemically oxidized or reduced. Alternatively, one or more materials in the electrochromic medium may undergo a change in phase during the operation of the device. For example, a material contained in solution in the ionically conducting electrolyte forms a layer on the electrically conducting electrode when electrochemically oxidized or reduced.

In addition, electrochromic medium 124 may include other materials, such as light absorbers, light stabilizers, thermal stabilizers, antioxidants, thickeners, viscosity modifiers, tint providing agents, redox buffers, and mixtures thereof. Suitable redox buffers include, among others, those disclosed in U.S. Pat. No. 6,188,505. Suitable UV-stabilizers may include, but are not limited to, 2-ethyl-2-cyano-3,3-diphenyl acrylate (Uvinul® N-35 or Viosorb® 910), (2-ethylhexyl)-2-cyano-3,3-diphenyl acrylate (Uvinul® N-539), 2-(2′-hydroxy-4′-methylphenyl)benzotriazole (Tinuvin® P), 3-[3-(2H-benzotriazole-2-yl)-5-(1,1-dimethylethyl)-4-hydroxyphenyl]propionic acid pentyl ester (prepared from Tinuvin® 213 via conventional hydrolysis followed by conventional esterification; hereinafter referred to as “Tinuvin PE”); 2,4-dihydroxybenzophenone, 2-hydroxy-4-methoxybenzophenone (Cyasorb® UV 9), and 2-ethyl-2′-ethoxyalanilide (Sanduvor® VSU).

Illustrative anodic materials may include, but are not limited to, ferrocene, substituted ferrocenes, substituted ferrocenyl salts, phenazine, substituted phenazines, phenothiazine, substituted phenothiazines including substituted dithiazines, thianthrene, and substituted thianthrenes. Examples of anodic materials may include di-tert-butyl-diethylferrocene, 5,10-dimethyl-5,10-dihydrophenazine (DMP), 3,7,10-trimethylphenothiazine, 2,3,7,8-tetramethoxy-thianthrene, 10-methylphenothiazine, tetramethylphenazine (TMP), bis(butyltriethylammonium)-para-methoxytriphenodithiazine (TPDT), polymer films such as polyaniline, polythiophene, and polymeric metallocenes, a solid transition metal oxides including, but not limited to, oxides of vanadium, nickel, iridium, as well as numerous heterocyclic compounds. It will be understood that numerous other anodic materials are contemplated for use including those disclosed in U.S. Pat. Nos. 4,902,108; 6,188,505; and 6,710,906.

Cathodic materials may include, but are not limited to, viologens such as methyl viologen tetrafluoroborate, octyl viologen tetrafluoroborate (octylviologen), or benzyl viologen tetrafluoroborate, ferrocinium salts such as and (6-(tri-tert-butylferrocinium)hexyl)triethylammonium di-tetrafluoroborate (TTBFc⁺), compounds disclosed in U.S. Pat. Nos. 7,046,41; 4,902,108; 6,188,505; and 6,710,906. Moreover, it is contemplated that the cathodic material may include a polymer film, such as various substituted polythiophenes, polymeric viologens, an inorganic film, or a solid transition metal oxide, including, but not limited to, tungsten oxide.

For illustrative purposes only, the concentration of the anodic and/or cathodic materials may range from about 1 millimolar (mM) to about 500 mM. This may include about 2 mM to about 100 mM. While particular concentrations of the anodic as well as cathodic materials have been provided, it will be understood that the desired concentration may vary greatly depending upon the geometric configuration of the chamber containing electrochromic medium 124.

Illustrative solvents for use in the electrochromic medium may include, but are not limited to, 3-methylsulfolane, dimethyl sulfoxide, dimethyl formamide, tetraglyme and other polyethers; alcohols such as ethoxyethanol; nitriles, such as acetonitrile, glutaronitrile, 3-hydroxypropionitrile, and 2-methylglutaronitrile; ketones including 2-acetylbutyrolactone, and cyclopentanone; cyclic esters including beta-propiolactone, gamma-butyrolactone, and gamma-valerolactone; propylene carbonate (PC), ethylene carbonate; and homogenous mixtures of the same. While specific solvents have been disclosed as being associated with the electrochromic medium, numerous other solvents that would be known to those having ordinary skill in the art having the present disclosure before them are likewise contemplated for use.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed:

1. An electrochromic device, comprising:
at least one fill port;
a primary plug material associated with the at least one fill port; and
a metal-based sealing member over-covering the primary plug material.

2. The electrochromic device of claim 1, wherein the metal-based sealing member comprises tin, a tin alloy, a tin solder, silver, a silver alloy, a silver solder, zinc, a zinc alloy, a zinc solder, antimony, an antimony alloy, an antimony solder, silver, a silver alloy, a silver solder, aluminum, an aluminum alloy, an aluminum solder, germanium, a germanium alloy, a germanium solder, titanium, a titanium alloy, a titanium solder, gold, a gold alloy, a gold solder, platinum, a platinum alloy, a platinum solder, copper, a copper alloy, a copper solder, palladium, a palladium alloy or a palladium solder.

3. The electrochromic device of claim 1, wherein the metal-based sealing member comprises tin.

4. The electrochromic device of claim 1, wherein the metal-based sealing member comprises tin, zinc, and silver.

5. The electrochromic device of claim 1, wherein the metal-based sealing member comprises 94.5±1.0 wt % tin, 4.0±1.0 wt % zinc, 1.0±0.3 wt % antimony, 0.1±0.2 wt % silver, 0.01±0.003 wt % aluminum, 0.01±0.003 wt % germanium, 0.005±0.002 wt % silicon, and 0.005±0.002 wt % titanium.

6. The electrochromic device of claim 1, wherein the metal-based sealing member comprises 90-100 wt % tin, 5 wt % antimony and 1-5 wt % zinc.

7. The electrochromic device of claim 1, wherein the metal-based sealing member comprises 94-96 wt % tin, 3-5 wt % antimony and 1-3 wt % zinc.

8. The electrochromic device of claim 1, wherein the metal-based sealing member comprises an indium and tin alloy.

9. The electrochromic device of claim 1, further comprising a second fill port, a second primary plug material associated with the second fill port; and a second metal-based sealing member over-covering the second primary plug material.

10. The electrochromic device of claim 1, wherein the device is an electrochromic window.

11. The electrochromic device of claim 1, wherein the device is an electrochromic aircraft transparency.

12. The electrochromic device of claim 1, wherein the device is an electrochromic mirror.

13. An electrochromic aircraft transparency, comprising:
a first substrate having an electrically conductive material associated therewith;
a second substrate having an electrically conductive material associated therewith;
a chamber positioned in a center of the electrochromic device, the chamber defined by the first substrate, the second substrate and two edge seals provided between the first substrate and the second substrates;
an electrochromic medium contained within the chamber;
at least one fill port extending between at least one of the first substrate and the second substrate and the chamber;
at least one plug associated with the at least one fill port; and
a metal sealing member disposed on a surface of the at least one of the first substrate and the second substrate, the metal sealing member configured to hermetically seal the at least one fill port.

14. The electrochromic aircraft transparency of claim 13, wherein the metal sealing member comprises tin, a tin alloy, a tin solder, silver, a silver alloy, a silver solder, zinc, a zinc alloy, a zinc solder, antimony, an antimony alloy, an antimony solder, silver, a silver alloy, a silver solder, aluminum, an aluminum alloy, an aluminum solder, germanium, a germanium alloy, a germanium solder, titanium, a titanium alloy, a titanium solder, gold, a gold alloy, a gold solder, platinum, a platinum alloy, a platinum solder, copper, a copper alloy, a copper solder, palladium, a palladium alloy or a palladium solder.

15. The electrochromic aircraft transparency of claim 13, wherein the metal sealing member comprises tin.

16. The electrochromic aircraft transparency of claim 13, wherein the metal sealing member comprises 94.5±1.0 wt % tin, 4.0±1.0 wt % zinc, 1.0±0.3 wt % antimony, 0.1±0.2 wt % silver, 0.01±0.003 wt % aluminum, 0.01±0.003 wt % germanium, 0.005±0.002 wt % silicon, and 0.005±0.002 wt % titanium.

17. The electrochromic aircraft transparency of claim 13, wherein the metal sealing member comprises an indium and tin alloy.

18. The electrochromic aircraft transparency of claim 13, wherein the metal sealing member comprises 90-100 wt % tin, 5 wt % antimony and 1-5 wt % zinc.

19. The electrochromic aircraft transparency of claim 13, wherein the metal sealing member comprises 94-96 wt % tin, 3-5 wt % antimony and 1-3 wt % zinc.
